(19) United States
(12) Patent Application Publication
(10) Pub. No.: US 2025/0159283 A1
(43) Pub. Date: May 15, 2025

(54) METHODS AND APPARATUS TO IDENTIFY STREAMING SESSIONS

(71) Applicant: The Nielsen Company (US), LLC, New York, NY (US)

(72) Inventors: Alexander Topchy, New Port Richey, FL (US); Jeremey M. Davis, New Port Richey, FL (US); Christen V. Nielsen, Dunedin, FL (US)

(21) Appl. No.: 19/019,369

(22) Filed: Jan. 13, 2025

Related U.S. Application Data
(63) Continuation of application No. 17/331,109, filed on May 26, 2021.
(60) Provisional application No. 63/030,888, filed on May 27, 2020.

(51) Int. Cl. H04N 21/442; H04N 21/81

(52) U.S. Cl. CPC H04N 21/44204; H04N 21/812

(57) ABSTRACT

Methods and apparatus to identify streaming sessions are disclosed. A disclosed apparatus for identifying streaming sessions includes an encoder to generate an identifier corresponding to a media file of an advertisement, a detector to determine a presence of the identifier in the advertisement presented at a media presentation device, a timing analyzer to determine a time at which the advertisement was presented, and an associator. The associator is to compare the identifier and the time to a streaming session log from a streaming service provider, identify a streaming session in which the advertisement associated with the identifier was presented at the time based on the comparison, and associate a panelist identifier corresponding to the media presentation device with a streaming session identifier corresponding to the streaming session.

### RELATED APPLICATION

This patent claims priority to U.S. Patent Application Ser. No. 63/030,888, which was filed on May 27, 2020. U.S. Patent Application Ser. No. 63/030,888 is hereby incorporated herein by reference in its entirety.

### FIELD OF THE DISCLOSURE

This disclosure relates generally to media monitoring and, more particularly, to methods and apparatus to identify streaming sessions.

### BACKGROUND

A streaming service provider (SSP) has a large library of content that can be received by users on their viewing devices (e.g., smart TVs, smart phones, personal computers, etc.). Such devices may enable viewing through a dedicated application (e.g., an executable application, a web application, etc.). The application may be offered by the SSP, available for download/installation on the device, and/or installed by a manufacturer and/or distributor of the device.

### BRIEF DESCRIPTION OF THE DRAWINGS

FIG. 1 is a block diagram of an example environment in which the methods and apparatus for identifying streaming sessions may be implemented.

FIG. 2 is a schematic overview of an example panelist identifier system in accordance with teachings of this disclosure.

FIGS. 3A and 3B illustrate an example analysis that can be implemented in examples disclosed herein.

FIGS. 4-10 are flowcharts representative of machine readable instructions which may be executed to implement one or more devices of the environment of FIG. 1 and/or the example panelist identifier system of FIG. 2.

FIG. 11 is a block diagram of an example processing platform structured to execute instructions to implement one or more devices of the environment of FIG. 1 and/or the example panelist identifier system of FIG. 2.

FIG. 12 is a block diagram of an example software distribution platform to distribute software (e.g., software corresponding to the example computer readable instructions of FIGS. 4-10) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein “substantially real time” refers to occurrence in a near instantaneous manner recognizing there may be real world delays for computing time, transmission, etc. Thus, unless otherwise specified, “substantially real time” refers to real time+/−1 second.

### DETAILED DESCRIPTION

Traditionally, audience measurement entities (also referred to herein as “ratings entities”) determine demographic reach for advertising and media programming based on registered panel members or panelists. That is, an audience measurement entity enrolls people that consent to being monitored into a panel. During enrollment, the audience measurement entity receives demographic information from the enrolling people so that subsequent correlations may be made between advertisement/media exposure to those panelists and different demographic markets.

Audience measurement entities and/or Streaming Service Providers (SSPs) want to determine audience measurement data for panelists viewing their streams. Each streaming session includes a number of Video clips (main content) and Advertisement clips played on the user device. For example, SSPs can be interested in obtaining audience composition data from the audience measurement entity (e.g., because the SSPs already have media streaming logs of the media sent to devices). Specifically, the SSPs expect that an audience measurement entity can assign viewers (e.g., assign demographic information from panelists) to each streaming session of a panelist.

Examples disclosed herein enable accurate determination of audience measurement entity panelists with respect to viewing sessions while overcoming current constraints on the traditional means used in television audience measurement (TAM). Examples disclosed herein utilize an identifier such that the identifier is played at a certain time. In turn, the identifier and time in conjunction with a streaming session log can be utilized to determine a panelist and/or panelist information. As a result, a panelist can be associated with a specific streaming session. In other words, the streaming session and/or exposure thereof can be identified.

Some examples disclosed herein utilize watermarking (e.g., real-time or concurrent watermarking) of content of an SSP content library. Additionally or alternatively, fingerprinting of the content is implemented. For example fingerprinting of provided media files from an SSP is performed. Examples disclosed herein can take advantage of currently deployed meters and associated technology stack such that existing hardware can be utilized.

In some examples, the SSP submits commercials/advertisements to an audience measurement entity for audio fingerprinting on a rolling basis to create a reference database of fingerprinted clips. In some such examples, the audience measurement entity can then match a panelist audio fingerprint against the reference database and recognize the instance of time when such clips were successfully matched. In some examples, fingerprinted and/or watermarked clips are identified along with a detection time to determine panelist data without a reference database. Accordingly, panelists can be identified based on a randomness of detection time.

As used herein, the terms “commercial” and “advertisement” refer to content that is used to advertise. Accordingly, the terms “commercial” and “advertisement” can refer to media content including, but not limited to, video, audio clips, audio files, animations, images, image stills, clips, banner advertisements, etc.

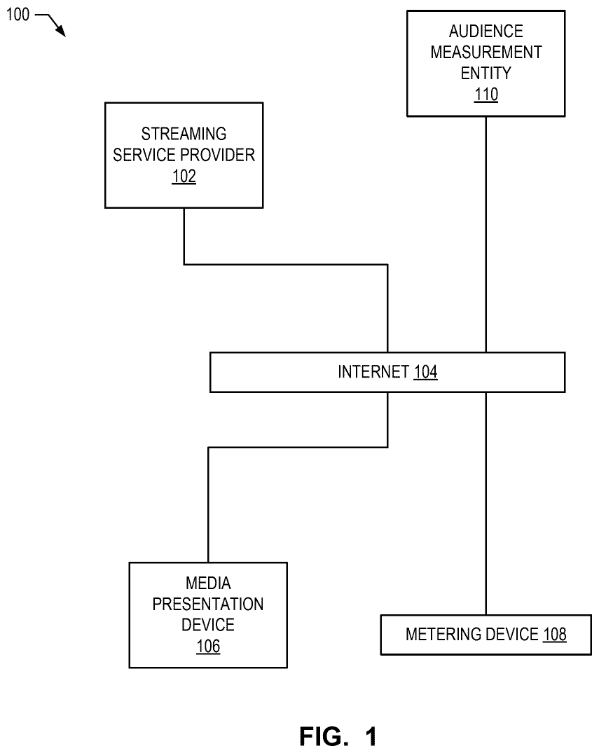

Turning to FIG. 1, in an example environment 100, an example SSP 102 transmits streaming media (e.g., programs, commercials, etc.) via the Internet or network 104 to a media presentation device 106. An example metering device 108 collects audience measurement information about the presentation of media on the media presentation device 106. The example metering device 108 transmits the collected audience measurement information to an audience measurement entity 110 via the Internet 104.

While a single SSP 102 is illustrated, the environment 100 may include any number of SSPs and the SSP 102 may comprise any number of components at any number of locations (e.g., servers that are physically distributed throughout a geographic region).

The Internet 104 may be replaced or complemented with any other network(s) (e.g., a wide area network, a local area network, etc.). Further, any appropriate network and/or computing topology can be implemented instead.

The media presentation device 106 of the illustrated example is a smart television. Alternatively, the media presentation device 106 may be any other type of device (e.g., a smart phone, a personal computer, a set top box, etc.). While a single media presentation location including the media presentation device 106 is illustrated, the environment 100 may include any number of media presentation locations and any number of media presentation devices. The media presentation includes an application for presenting the media from the SSP 102. Typically, the SSP 102 knows a unique client player identifier or application identifier which is streaming their content. This information may be set during the streaming initialization and/or may be transmitted in a backchannel when a clip is being streamed.

The metering device 108 of the illustrated example is a panelist metering device supplied to a media presentation location (e.g., a home of a panelist) by the audience measurement entity 110. The example metering device 108 monitors the presentation of media by the media presentation device 106 and transmits collected audience measurement information to the audience measurement entity 110 via the Internet 104. For example, the metering device 108 may include a microphone or other capture device to capture the media, characteristics of the media, etc. to identify the media (e.g., to collect watermarks, signatures, embedded metadata, etc.). The metering device 108 may additionally or alternatively capture information about people present in the room during the media presentation (e.g., utilizing cameras, user input, sensors, etc.). While the metering device 108 is a device separate from the media presentation device 106, the metering device 108 may alternatively be integrated with media presentation device 106.

The audience measurement entity 110 receives the audience measurement information from the metering device 108. In turn, the audience measurement entity 110 can perform numerous actions using the audience measurement information such as, for example, aggregating information, analyzing the information to determine an identity for the media, analyzing the information to determine an identity for the audience, generating reports, linking the information with information from other sources (e.g., information from the SSP 102), and/or other any actions.

Several example approaches to facilitate the association of panelists with streaming sessions are encompassed by examples disclosed herein. The disclosed example approaches may be utilized individually or in combination. The example approaches described below encompass example aspects that can be implemented in the example environment 100.

In a first example approach, while a viewing session is in progress, the SSP 102 inserts commercials. Commercial insertion is controlled by the SSP 102 in terms of timing and choice of advertisement identifier (Ad ID). According to the first example approach, commercials are watermarked with a message having a unique Ad ID for each commercial (e.g., the SSP 102 or the commercial provider inserts unique Ad IDs into the commercials, the audience measurement entity 110 provides a watermarking device and/or directs the SSP 102 to watermark the commercials, etc.).

In some examples, when a commercial is presented by the media presentation device 106, the metering device 108 detects the watermark associated with the commercial and logs the time of the presentation. Such detections may happen more than one time with different commercials viewed throughout the streaming session. The end result is a log of detections of Ad IDs and corresponding times stored at the metering device 108. For example, a sequence of pairs {Ad Id1, Time 1}, {Ad Id2, Time 2}, {Ad Id3, Time 3}, . . . , observed at the metering device 108. Additionally, the collected audience measurement information is associated with the panelist associated with the metering device 108. In turn, the metering device 108 transmits the log to the audience measurement entity 110.

In the illustrated example, the SSP 102 provides a streaming session log to the audience measurement entity 110. The streaming session log can include streaming session identifiers, ground truth data of the Ad IDs, and time of presentation for each commercial of a streaming session. The example audience measurement entity 110 can then match the streaming session log with the audience measurement information from the metering device 108 to identify a matching streaming session for the audience measurement information. For example, the particular Ad IDs and presentation times are likely unique enough that information from the metering device 108 will be matched to a single streaming session from the streaming session log. Accordingly, the panelist identifier associated with the audience measurement information from the metering device 108 can be matched to a streaming session identifier from the streaming session log. To further reduce the possibility of two streaming sessions having matching Ad IDs and presentation times, the SSP 102 can employ a restriction rule to choose different commercials for presentation to different media presentation devices 106 at the same or similar time of streaming, for example.

According to examples disclosed herein, watermarking of the commercials can be done in an offline mode (e.g., prior to the time of presentation since the watermark does not necessitate presentation-time information, such as the time of presentation). However, in some examples, the watermark payload for Ads may be generated dynamically in real-time. For example, real-time encoding can insert a unique session ID or its equivalent, for instance it can insert a unique target player identifier. Additionally or alternatively, the real-time encoding can insert a unique IP address for the end-point device. This information or any other available information can be used to supplement the matching process to further uniquely identify a session.

Once correspondence between a streaming session identifier and the panelist is established, the audience measurement entity 110 can prepare its audience data reports for the SSP 102 in aggregate for a number of viewing sessions, or parts of viewing session. In some examples, the audience measurement entity 110 may provide a report of the links between streaming session identifiers and panelist identifiers, panelist demographic information, etc. Alternatively, the audience measurement entity 110 may aggregate information about the panelist demographics and the streaming session identifier to protect the identities of particular panelists and/or to prevent the SSP 102 from targeting information to known panelists.

According to a second example approach in accordance with teachings of this disclosure, the audience measurement entity 110 requests that and/or causes the SSP 102 provides a probing tool to be installed in/onto the metering device 108 and/or in the media presentation device 106 to allow the metering device 108 to discover a player identifier that uniquely identifies the media presentation device 106 (e.g., uniquely identifies the application for playing the media on the streaming media on the media presentation device 106). Accordingly, the metering device 108 can link the panelist identifier with the player identifier. As a result, the example audience measurement entity 110 can then receive a table linking the player identifiers with session identifiers from the SSP 102 and, in turn, can determine and provide the linking of player identifiers with panelist identifiers (or information about the panelists (e.g., demographic information)) to the SSP 102.

According to a third example approach, the audience measurement entity 110 instructs and/or requests a panelist associated with the media presentation device 106 to open the application for playing media from the SSP 102 and play a special pre-generated media clip from the SSP 102. The media clip can be pre-generated by the audience measurement entity 110 or the SSP 102 to include a unique URL or other identifier at the SSP 102. The audience measurement entity 110 provides information linking the panelist to the unique media clip (e.g., provides a unique identifier (that may be different from the actual panelist identifier for privacy reasons)) of the panelist that was instructed to load a particular media clip. When the media presentation device 106 requests a “personalized” clip/URL, the SSP 102 can determine both the identity of the player (e.g., because the SSP 102 receives information about the player application that requested the media) and information about the panelist (e.g., because the clip/URL is uniquely associated with the panelist).

In this example, once the SSP 102 has a linkage of a panelist identifier (or substitute identifier) with a player identifier, the SSP 102 can provide information about streaming sessions to the audience measurement entity 110 for the audience measurement entity 110 to use in generating reports of panelist activities (e.g., by generating reports that include demographic information).

In some examples, the example audience measurement entity 110 provides the instruction to the panelist to load the special clip when activating (e.g., incentives or full activation may be withheld until the special clip has been played). Alternatively, a technician of the audience measurement entity 110 may visit the panelist and load the clip during activation of the panelist with the audience measurement entity 110. According to examples disclosed herein, if the panelist obtains another media presentation device, the panelist will be requested to load the clip on the new device as well.

According to a fourth example approach, if the SSP 102 does not have an explicit player or client identifier in their application, the SSP 102 can still collect some information that may be utilized to uniquely identify the client (e.g. internet protocol (IP) address, device model, operating system version, device hardware identifiers, etc.). Thus, according to the fourth approach, the collected information may be utilized to perform the third approach in place of the player identifier.

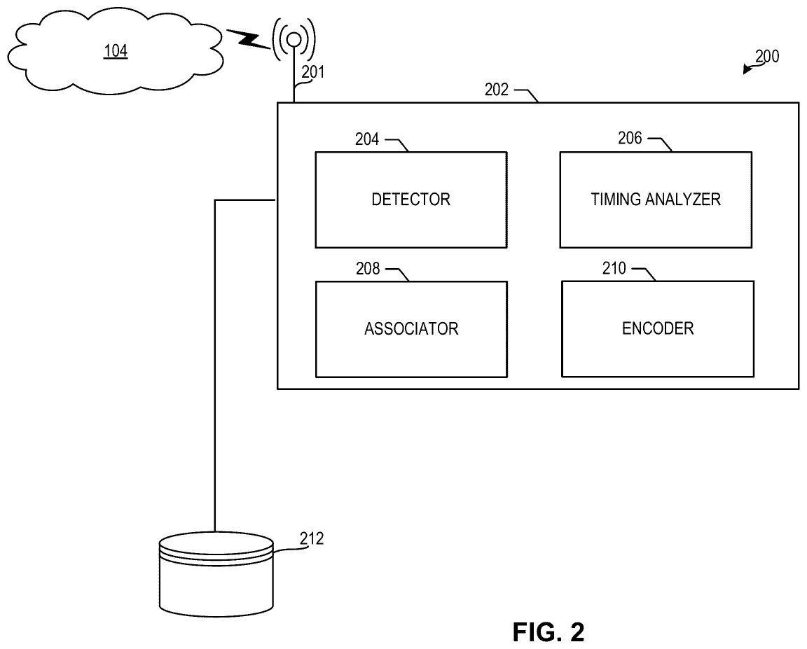

FIG. 2 is a schematic overview of an example panelist identifier system 200 in accordance with teachings of this disclosure. The panelist identifier system 200 of the illustrated example may be implemented in the audience measurement entity 110, the media presentation device 106, the metering device 108 and/or the SSP 102 of FIG. 1, and includes an example analyzer 202 with a transceiver 201 that is communicatively coupled to the network/internet 104 of FIG. 1. Further, the analyzer 202 is communicatively coupled to a data storage 212. In the illustrated example, the analyzer 202 includes an example detector 204, an example timing analyzer 206, an example associator 208 and an example encoder 210. In this example, panelist data is maintained with the audience measurement entity 110 and the SSP 102 does not have access to the panelist data.

The example detector 204 determines and/or monitors for a presence of identifiers (e.g., content identifiers, player identifiers, signatures and/or watermarks of streamed media advertisement files or advertisement media files). For example, the detector 204 determines a detection of a presence of the identifiers at the metering device 108 as content is presented on the media presentation device 106. The detected identifiers, signatures and/or watermarks may be measured and/or recorded at the metering device 108 shown in FIG. 1 and, subsequently are provided to the audience measurement entity 110 via the network 104 for analysis. In some examples, the detector 204 compares a received signature (e.g., an audio signature) from the metering device 108 to a database of known signatures stored in the data storage 212 to identify the signature and, thus, determine content (e.g., advertisement content, etc.) viewed by a viewer (e.g., a panelist viewer).

The example timing analyzer 206 determines a time in which media content associated with a commercial was presented to the aforementioned viewer and/or a panelist identifier associated with the viewer. In particular, the timing analyzer 206 is implemented to determine and store time information associated with the media content (e.g., a time in which the viewer views the media content with the media presentation device 106). In this example, the timing analyzer 206 stores time stamps (e.g., in hh: mm: ss format, in a numeric time format, etc.) associated with identified signatures or watermarks.

In the illustrated example, the associator 208 compares the identifiers and the time to a streaming session log and/or a network log to identify a streaming session in which the commercial was presented at the time. As a result, the example associator 208 associates the panelist identifier with a streaming session identifier. In some examples, the associator 208 determines a second identifier and a second time associated with a second commercial presented at the media presentation device 106. In some such examples, the comparison performed by the associator 208 is further based on when the second commercial was presented. In some examples, the associator 208 determines whether commercials are to be presented and/or whether probing tools are to be installed on the media presentation device 106.

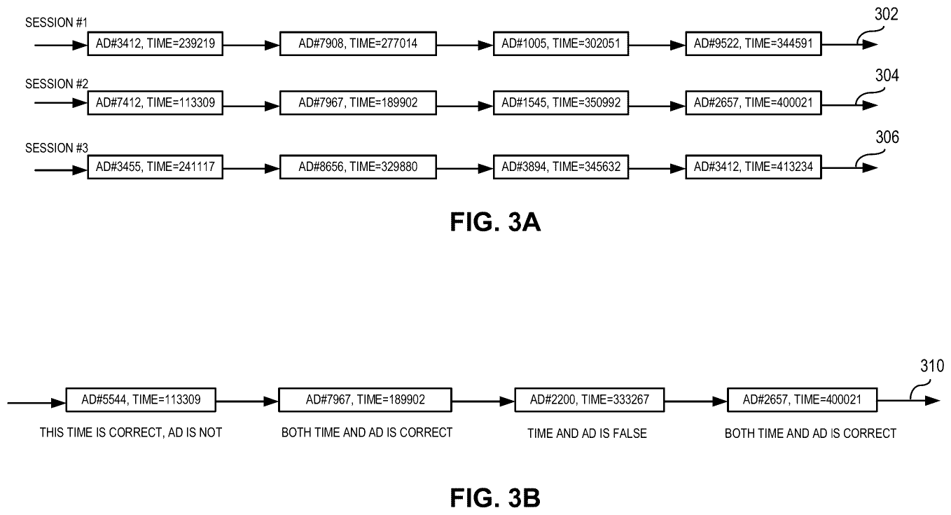

FIGS. 3A and 3B illustrate an example passive implementation analysis that can be implemented in examples disclosed herein. In this example, the SSP 102 has a finite number of advertisements injected into the streaming sessions reaching viewers and, thus, panelists. In the illustrated example of FIGS. 3A and 3B, the passive implementation refers to identifiers that are determined based on content submitted to the measurement entity 110 from the SSP 102.

Turning to FIG. 3A, in the illustrated example, three streaming sessions 302, 304, 306 are shown with corresponding advertisement identifier numbers and time stamps (e.g., time records). In this example, the streaming sessions 302, 304, 306 are streamed concurrently. However, the number of different clips of the streaming sessions 302, 304, 306 is significantly smaller than typically used for content recognition (e.g. multi-million size song libraries of streaming services). The example SSP 102 can submit advertisements to the audience measurement entity 110 for audio fingerprinting on a rolling basis to create a reference database of fingerprinted clips. For instance, the audience measurement entity 110 can maintain the most recent 45 days database of fingerprints from the SSP 102 with about 25,000 or 50,000 unique fingerprinted advertisements, for example. This may include any sounds or other aspect (e.g., a visual aspect, an encoded aspect, etc.) of the advertisements that the SSP 102 considers to be unique or desirable to its streaming playback (e.g., splash screen associate sounds, clip start, clip end, promos, custom ads, etc.). The sounds may be audio elements to be presented on consumer devices, such as the media presentation device 106.

In this example, the SSP 102 submits advertisements from its current roster of N clips to the audience measurement entity 110 for creating a reference database, or rather including into an existing database for (e.g., for video on demand (VOD) content). Accordingly, the audience measurement entity 110 matches audio fingerprints/signatures observed in the panel to this database (in addition to all other databases it may have for other measurement purposes). A reference of the SSP 102 will be updated according to specific SSPs, including newer media content, such as advertisement clips, and by retiring older advertisement clips out of circulation.

For panelists known by or associated with the audience measurement entity 110, content recognition is performed during viewing, which can include audio fingerprinting. For example, the audio fingerprinting algorithm is capable of recognizing relatively short clips streamed by the SSP 102 (e.g., 3, 6, or 10 second audio clips, etc.). An audio fingerprinting algorithm, such as StreamFP for example, can be implemented to recognize audio snippets (e.g., with durations of 6 seconds or shorter).

In this example, the SSP 102 maintains records/logs of what it is streaming and to where, including player ID for rendering their content, IP address, and may be even more identifying elements (OS or device type/characteristics, ISP, etc.). This includes the instances of including advertisements, and any other audio elements, into the streams. For example, the different streaming sessions 302, 304, 306 will have time-ordered events of advertisements as shown in the example of FIG. 3A.

Turning to FIG. 3B, the audience measurement entity 110 of the illustrated example measures media consumption for its panelists, including computing audio fingerprints. These fingerprints can produce positive matches against the fingerprints contributed by the SSP 102. For a particular panelist, the audience measurement entity 110 may observe a sequence of advertisement matches that includes true positive matches, erroneous or false positive matches, and also may miss some advertisements streamed to the aforementioned panelist.

In the illustrated view of FIG. 3B, the audience measurement entity 110 has a panelist whose streaming was logged by the SSP 102 as the session 304 of FIG. 3A. In this example, the log is represented by a detection stream 310. However, the audience measurement entity 110 performs a measurement of this panelist with some of the advertisements recognized correctly while others were not. Also, occasional false detections may occur.

In this example, the audience measurement entity 110 searches and matches logs (e.g., streaming session logs, IP address logs, data streams, etc.). For example, viewing detection logs as measured by the audience measurement entity 110 can be matched against streaming logs from the SSP 102 for valid matches to be found. Generally, in this example, the SSP 102 does not match panelist identifiers while, in contrast, the audience measurement entity 110 maintains the panelist identifiers. As a result, the SSP 102 does not access and may be unaware of panelist identities (e.g., households that operate as panelists or panelist IP address). In other examples, though, the SSP 102 may identify the panelist. In some examples, the audience measurement entity 110 and the SSP 102 utilize an intermediary for data anonymizing and facilitating blind matching, and, thus, enabling creation of reports in aggregate to avoid exposure of individual panelists. In some examples, respondent level data exchange with the SSP 102 may be avoided.

In some examples, a link is established between SSPs streamed content to a Player ID (known to the SSP 102 only) and a particular panelist household audience associated with the audience measurement entity 110. Multiple links like this can be aggregated by demographics, or other relevant marketing segments, and can provide the SSP 102 required information about the audience of streaming content of the SSP 102 on Smart TVs, or any other type of media device, for example. In effect, this example is passive (e.g., completely passive) for the SSP 102. In other words, audio and/or video streams are not altered (e.g., not watermarked).

In contrast to the examples of FIGS. 3A and 3B, other examples can include an active implementation such that media content is altered (e.g., watermarked). As a result, a library of pre-encoded clips, as described above in connection with FIGS. 3A and 3B, or even inserting different payloads “on the fly” is not necessary. In particular, an inserted Player ID can be avoided. These active implementations can utilize one or a small number of watermarked clips, which can be audio or video clips, for example.

In a first example active implementation, one relatively constant watermark for all clips and all insertions (e.g., splash screen, promotional advertisements) is utilized. This watermark can carry a dedicated seed (SID) given to the SSP 102 from the audience measurement entity 110. In some examples, the audience measurement entity 110 decodes the watermark and adds or appends occurrences of the watermark to a linked log. In some examples, the SSP 102 records instances when this watermarked content has been streamed to a particular Player ID. In contrast to the passive solution, advertisement detection via database matching is not implemented and, instead, a watermark detection is utilized. The linking of panelist data results from randomness of detection time.

In a second example active implementation, multiple watermarks are implemented and/or encoded at random (e.g., random placement, random times, random periods, etc.) for the same clips as in the first example active implementation. This enables more resolution power, as well as shorter logs. The linking to panelist data is driven both by randomness of detection time and randomness of watermark sequence(s). For example, the audience measurement entity 110 can issue 32 different seeds (SIDs) to the SSP 102. In turn, SSP 102 will randomly use the different SIDs. Each detection of a watermark shortens the required length of the sequence by 32. Accordingly, more uniqueness is enabled.

In a third example active implementation, a seed and a random time in content (TIC) are implemented. In such an example, the TIC does not include information specific to panelists and/or the audience measurement entity 110 to identify the Player ID. The uniqueness can be increased significantly due to a TIC field having at least 29 bits, for example. In this example, a great deal of panelist linking can occur with the TIC, however, detection time is still available as in other examples disclosed herein.

In a fourth example active implementation, a watermark is generated “on the fly” for placement onto media content. For example, the watermark can be inserted at the SSP 102 as the advertisement is being streamed. The watermark can be constant and/or associated with a specific server (e.g., a unique watermark assigned to a server), for example. Additionally or alternatively, the watermark can be varied over time (e.g., at periodic time intervals, etc.).

While an example manner of implementing the example panelist identifier system 200 of FIG. 2 is illustrated in FIG. 2, one or more of the elements, processes and/or devices illustrated in FIG. 2 may be combined, divided, re-arranged, omitted, eliminated and/or implemented in any other way. Further, the example detector 204, the example timing analyzer 206, the example associator 208, the encoder 210 and/or, more generally, the example panelist identifier system 200 of FIG. 2 may be implemented by hardware, software, firmware and/or any combination of hardware, software and/or firmware. Thus, for example, any of the example detector 204, the example timing analyzer 206, the example associator 208, the encoder 210 and/or, more generally, the example panelist identifier system 200 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example detector 204, the example timing analyzer 206, the example associator 208, the encoder 210 is/are hereby expressly defined to include a non-transitory computer readable storage device or storage disk such as a memory, a digital versatile disk (DVD), a compact disk (CD), a Blu-ray disk, etc. including the software and/or firmware. Further still, the example panelist identifier system 200 of FIG. 2 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

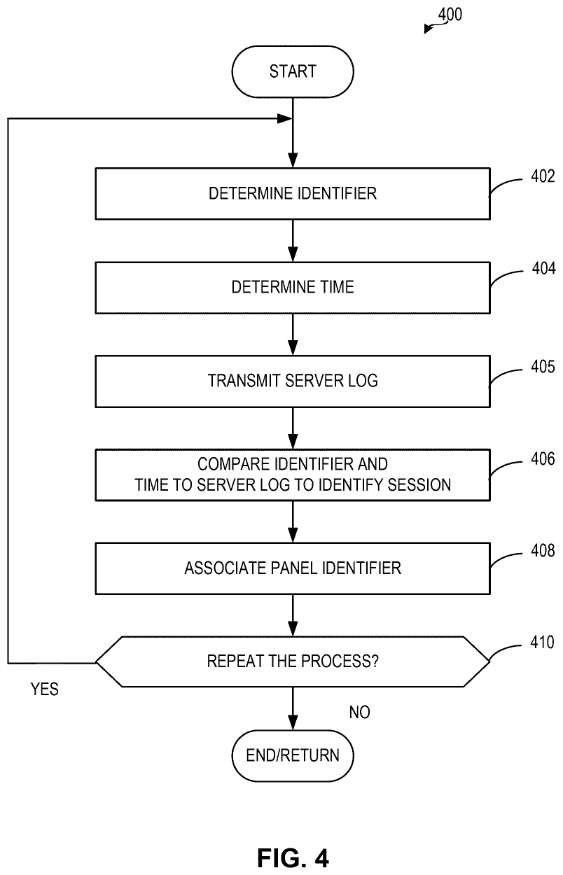

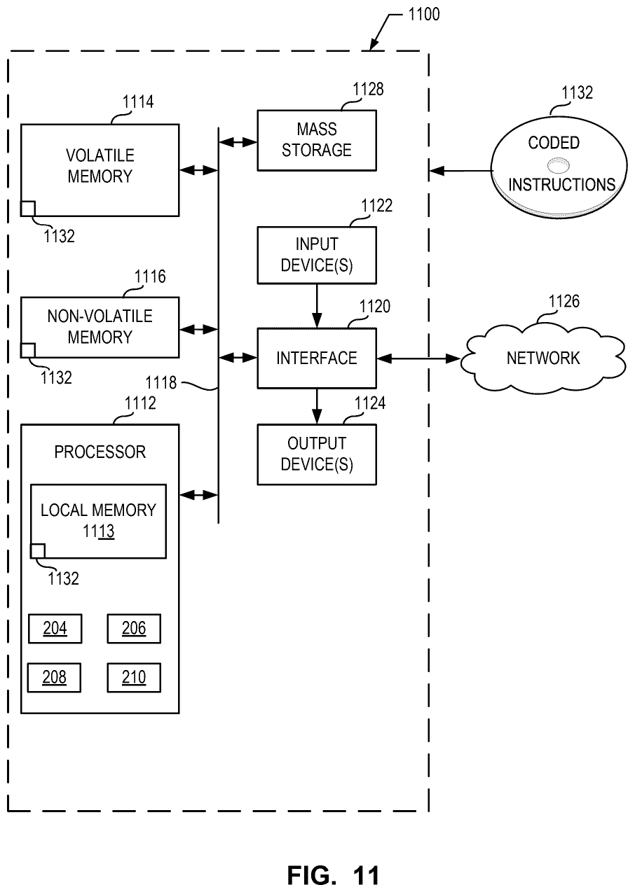

Flowcharts representative of example hardware logic, machine readable instructions, hardware implemented state machines, and/or any combination thereof for implementing the example panelist identifier system 200 of FIG. 2 are shown in FIGS. 4-10. The machine readable instructions may be one or more executable programs or portion(s) of an executable program for execution by a computer processor and/or processor circuitry, such as the processor 1112 shown in the example processor platform 1100 discussed below in connection with FIG. 11. The program may be embodied in software stored on a non-transitory computer readable storage medium such as a CD-ROM, a floppy disk, a hard drive, a DVD, a Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowcharts illustrated in FIGS. 4-10, many other methods of implementing the example panelist identifier system 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit. The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 4-10 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The example method 400 of FIG. 4 begins as the SSP 102 is providing streaming media content to the media presentation device 106. In this example, the metering device 108 is monitoring content being viewed on the media presentation device 106.

At block 402, the detector 204 identifies an identifier (e.g., a content identifier, a watermark, a signature, a known signature, etc.) received from the network 104 via the transceiver 201. The identifier can be a watermark, a signature, a unique identifier, a player identifier, a panelist identifier, etc.

In the illustrated example, at block 404, the timing analyzer 206 determines a time (e.g., a timestamp) associated with when the identifier is streamed and/or observed or viewed by a viewer. In this example, the time is stored as a numeric value.

At block 405, a server log of the SSP 102 is transmitted so that at block 406, the associator 208 of the illustrated example compares the time and the identifier to the server log to identify and/or characterize a streaming session. In this example, the time and the identifier are linked to a server streaming session of the SSP 102. In some examples, the server streaming session of the SSP 102 is provided to the audience measurement entity 110.

At block 408, in some examples, the associator 208 associates a panel identifier with the time and the identifier. In particular, the associator 208 utilizes the timing of when the identifier is encountered (e.g., streamed, listened viewed) at the metering device 108 and/or the media presentation device 106 based on the server log, for example.

At block 410, it is determined whether to repeat the process. If the process is to be repeated (block 410), control of the process returns to block 402. Otherwise, the process ends/returns.

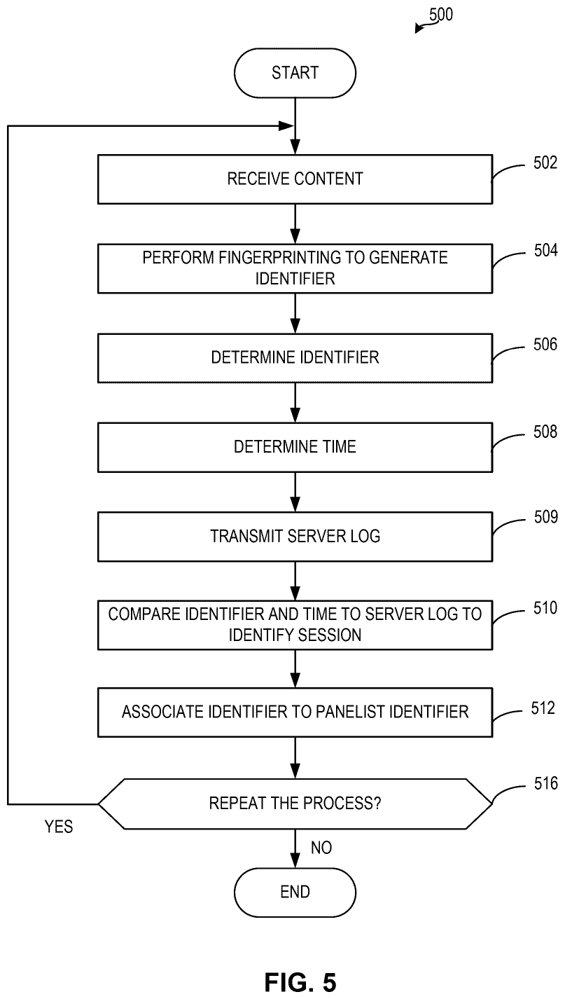

The example method 500 of FIG. 5 is a passive implementation example and begins as the SSP 102 is providing streaming media content to the media presentation device 106. The metering device 108 is monitoring content being viewed on the media presentation device 106.

At block 502, media content and/or clips (e.g., advertisement clips) are received at the audience measurement entity 110 from the SSP 102 via the network 104. In this example, the media content and/or clips are provided by the SSP 102 to the media presentation device 106. However, in other examples, the media content and/or clips may be provided by an intermediary. In this example, the media content may be an advertisement and/or a commercial.

At block 504, the encoder 210 of the illustrated example performs fingerprinting of the media content and/or clips. In some examples, audio signatures of the media content and/or clips are generated and stored in the data storage 212. In other examples, the SSP 102 submits advertisements to the audience measurement entity 110 for audio fingerprinting on a rolling basis to create a reference database of fingerprinted clips. Additionally, in this example, an audio fingerprinting algorithm can be utilized by the encoder 210.

At block 506, the detector 204 identifies an identifier, which is based on a known signature received from the SSP 102 in this example. In another example, an audience measurement entity 110 matches audio fingerprints/signatures to the aforementioned reference database.

In the illustrated example, at block 508, the timing analyzer 206 determines a time (e.g., a timestamp) associated with when the identifier is streamed and/or observed or viewed by a viewer. In this example, the time is stored as a numeric value.

At block 509, a server log of the SSP 102 is transmitted to the audience measurement entity 110, for example. In this example, the time and the identifier are linked to a server streaming session of the SSP 102. In this example, the server log records what the SSP is streaming and to where, such as OS or device type/characteristic, ISP, etc. This includes the instances of including advertisements, and any other audio elements, into the streams.

At block 510, the associator 208 compares the time and the identifier to the server log to identify and/or characterize a streaming session.

At block 512, in some examples, the example associator 208 associates a panel identifier with the time and the identifier. In particular, the associator 208 utilizes the timing of when the identifier is encountered (e.g., streamed, listened, viewed, etc.) at the metering device 108 and/or the media presentation device 106. In some examples, the viewing detection logs as measured by the audience measurement entity 110 is matched against streaming logs from the SSP 102 for valid matches to be found. In other examples, a link is established between SSPs streamed content to a Player ID (known to SSP only) and a particular panelist household audience associated with the audience measurement entity.

At block 516, it is determined whether to repeat the process. If the process is to be repeated (block 516), control of the process returns to block 502. Otherwise, the process ends. This determination may be based on whether additional clips are received from the SSP 102 at the audience measurement entity 110 for fingerprinting and subsequent identification.

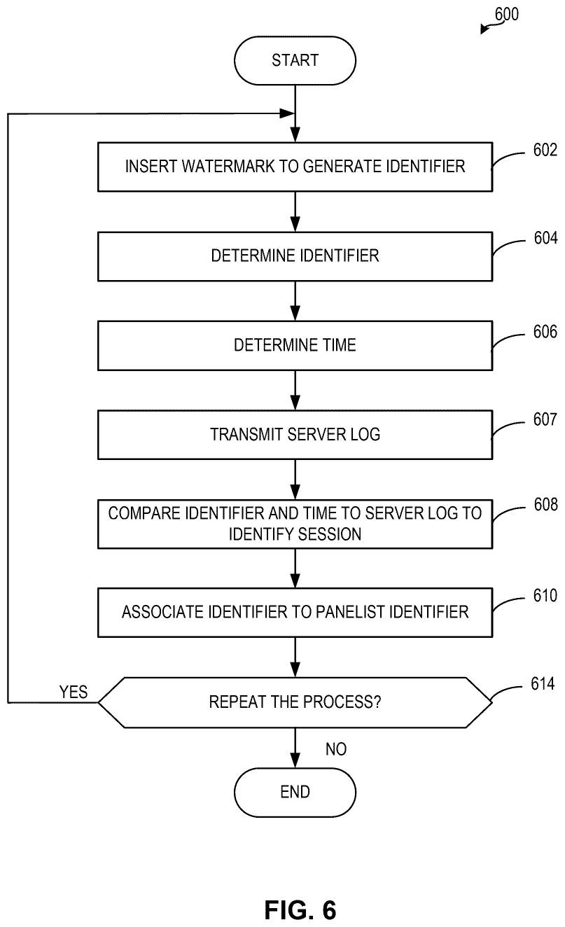

The example method 600 of FIG. 6 is an active implementation example and begins as the SSP 102 is providing streaming media content to the media presentation device 106. In this example, the metering device 108 is monitoring content being viewed on the media presentation device 106 via watermarks generated at the SSP 102. In this example, the watermarks are to be placed onto/inserted into the media content during streaming thereof.

At block 602, a watermark is inserted into media content and/or clips (e.g., advertisement clips) by the example encoder 210. However, in other examples, the media content and/or clips are watermarked by an intermediary and/or the audience measurement entity 110. In this example, the watermark may carry a dedicated seed (SID) given to the SSP 102 from an audience measurement entity 110. In other examples, multiple watermarks are implemented at random (e.g., random placement, random times, random periods, etc.). Or, in other examples, a seed (SID) and a random time in content (TIC) are implemented or a watermark is generated “on the fly”.

At block 604, the detector 204 determines an identifier, which is the aforementioned watermark in this example.

In the illustrated example, at block 606, the timing analyzer 206 determines a time (e.g., a timestamp) associated with when the identifier is streamed, viewed and/or observed by a viewer. In this example, the time is stored as a numeric value.

At block 607, a server log of the SSP 102 is transmitted to the audience measurement entity 110.

At block 608, the associator 208 of the illustrated example compares the time and the identifier to the server log. In this example, the time and the identifier are linked to a server streaming session of the SSP 102. As a result, the streaming session is identified. In some examples, the audience measurement entity 110 decodes the watermarks and adds or appends occurrences of the watermarks to a linked log.

At block 610, in some examples, the example associator 208 associates a panel identifier with the time and the identifier. In particular, the associator 208 utilizes the timing of when the identifier is encountered (e.g., streamed, listened viewed) at the metering device 108 and/or the media presentation device 106. In some examples, the SSP 102 records instances when the watermarked content has been streamed to a particular Player ID.

At block 614, it is determined whether to repeat the process. If the process is to be repeated (block 614), control of the process returns to block 602. Otherwise, the process ends. This determination may be based on whether additional clips are to be watermarked by the SSP 102.

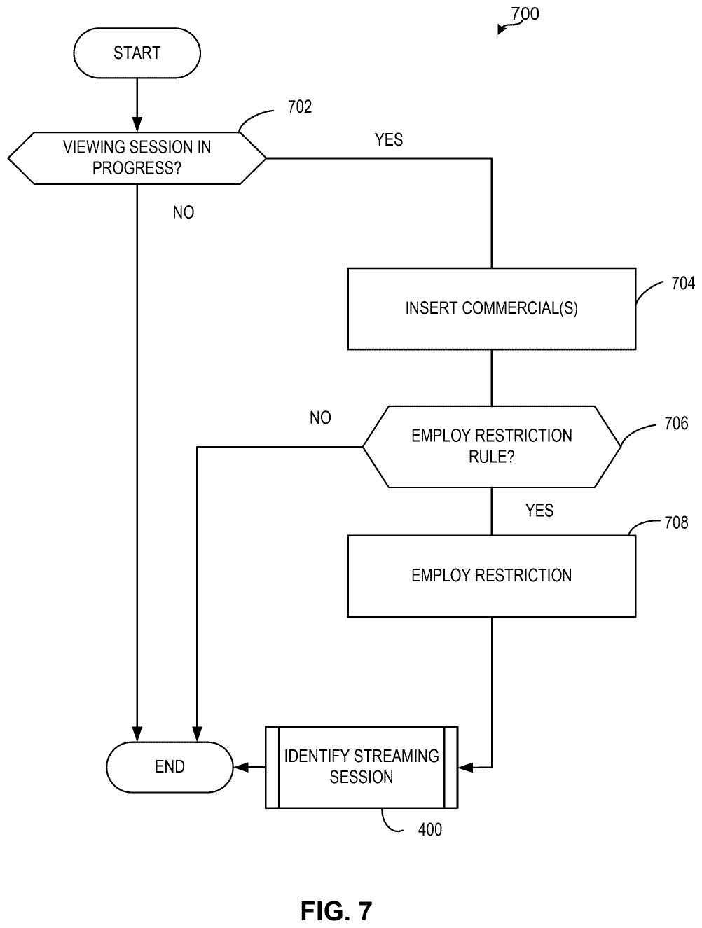

The example method 700 of FIG. 7 begins as a viewing session is in progress. The example method 700 corresponds to an approach in which commercials are inserted to a streaming session such that restriction rules are employed. In particular, the restriction rules can be utilized to select specific commercials for presentation to different media presentation devices 106 via streaming.

At block 702, it is determined whether a viewing session is in progress on the media presentation device 106. If there is no viewing session in progress (block 702), the process ends. Otherwise, the process proceeds to block 704.

In this example, at block 704, the encoder 210 and/or the SSP 102 inserts a commercial on the media presentation device 106 during the viewing session.

At block 706, it is determined by the associator 208 and/or the SSP 102 whether to employ a restriction rule. The restriction rule can determine which commercials are presented at different ones of media presentation devices 106 and, in turn, the streaming sessions of the different media presentation devices 106 can have different corresponding Ad IDs. If the restriction rule is employed (block 706), the process continues to subroutine 400 in which a panelist identifier is identified and, subsequently, block 708 in which the restriction is employed. Otherwise, the process ends.

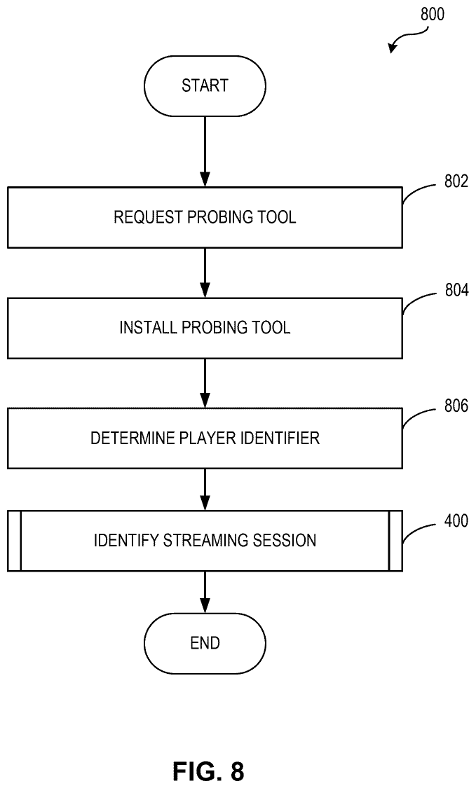

The example method 800 of FIG. 8 corresponds to an example implementation utilizing probing tools. The probing tools can be installed onto the media presentation device 106 to enable determination of a unique player identifier.

At block 802, the associator 208 and/or the SSP 102 requests a probing tool be placed onto the media presentation device 106.

At block, 804 the probing tool is installed by the encoder 210 onto the metering device 108 and/or the media presentation device 106. Additionally or alternatively, a user installs the probing tool onto the metering device 108 and/or the media presentation device 106.

At block 806, the example detector 204 determines a player identifier that uniquely identifies the media presentation device 106 via the aforementioned probing tool. The process continues to subroutine 400 and the process ends.

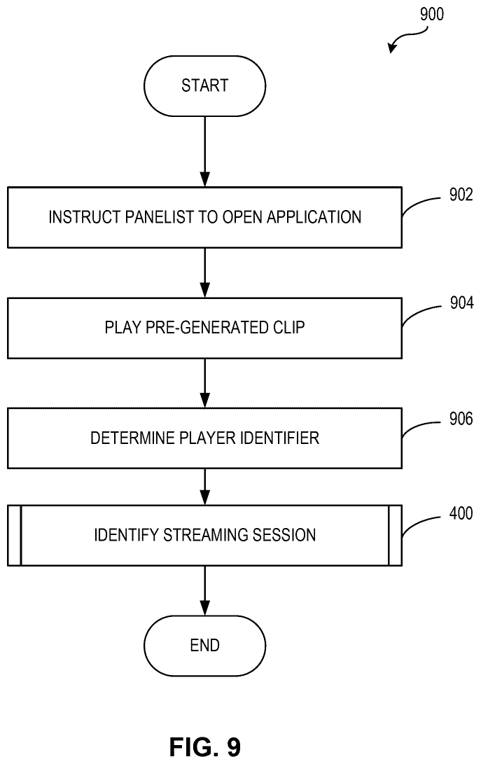

The example method 900 of FIG. 9 corresponds to an example approach in which a pre-generated media clip is played on the media presentation device 106 to link a panelist identifier with a player identifier. For example, the media presentation device 106 requests the clip and at least one of the identity of the player and information about the panelist can be determined.

At block 902, a panelist is instructed by the associator 208 and/or the audience measurement entity 110 to open an application that plays a media file.

At block 904, a pre-generated clip is showed and/or played on the media presentation device 106. In some examples, the pre generated clip is at least one of a “personalized” clip or a URL.

At block 906, the detector 204 and/or the SSP 102 determines a player identifier based on the pre-generated clip, for example.

At subroutine 400, the streaming session is identified and the process ends.

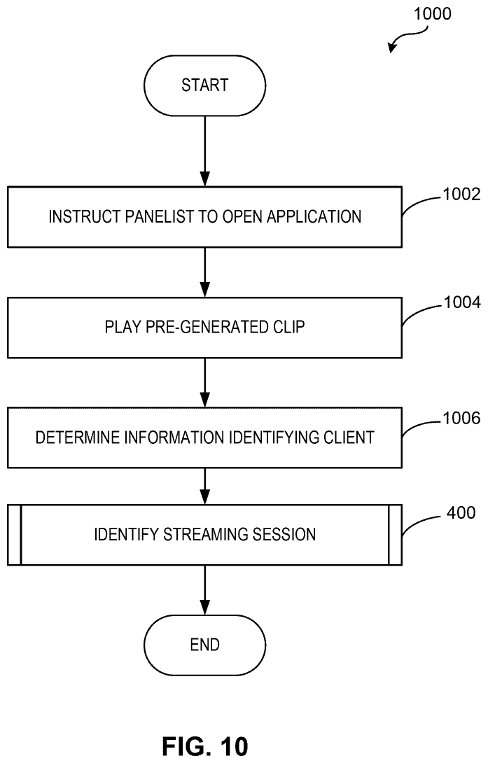

FIG. 10 is flowchart of an example method 1000 in which no explicit player identifier is utilized. Instead, information is collected to identify a player and/or media presentation device.

At block 1002, a panelist is instructed by the associator 208 and/or the audience measurement entity 110 to open an application that plays a media file.

At block 1004, in some examples, a pre-generated clip is shown and/or played on the media presentation device 106 of the unique player to determine identifiers associated with the media presentation device.

At block 1006, information identifying a client is determined by the detector 204 and/or the SSP 102 via collected information about the media presentation device 106, such as, but not limited to, the IP address, device model, operating system version, and/or device hardware identifiers, etc.

At subroutine 400, the streaming session is identified and the process ends.

FIG. 11 is a block diagram of an example processor platform 1100 structured to execute the instructions of FIGS. 4-10 to implement the example panelist identifier system 200 of FIG. 2. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example detector 204, the example timing analyzer 206, the example associator 208 and the example encoder 210.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuit 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives.

The machine executable instructions 1132 of FIGS. 4-10 may be stored in the mass storage device 1128, in the volatile memory 1114, in the non-volatile memory 1116, and/or on a removable non-transitory computer readable storage medium such as a CD or DVD.

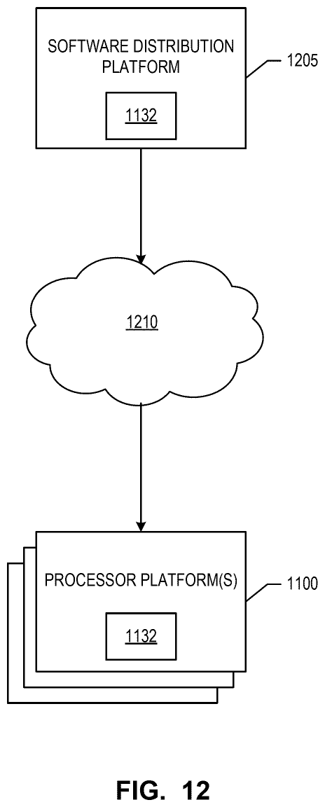

A block diagram illustrating an example software distribution platform 1205 to distribute software such as the example computer readable instructions 1132 of FIG. 11 to third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1132 of FIG. 11. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the computer readable instructions 1132, which may correspond to the example computer readable instructions 1132 of FIGS. 4-10, as described above. The one or more servers of the example software distribution platform 1205 are in communication with a network 1210, which may correspond to any one or more of the Internet and/or any of the example networks 104, 1126 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1132 from the software distribution platform 1205. For example, the software, which may correspond to the example computer readable instructions 400, 500, 600, 700, 800, 900, 1000 of FIGS. 4-10, may be downloaded to the example processor platform 1100, which is to execute the computer readable instructions 1132 to implement the environment 100 of FIG. 1 and/or the example panelist identifier system 200 of FIG. 2. In some example, one or more servers of the software distribution platform 1205 periodically offer, transmit, and/or force updates to the software (e.g., the example computer readable instructions 1132 of FIG. 11) to ensure improvements, patches, updates, etc. are distributed and applied to the software at the end user devices.

Example 1 includes an apparatus for identifying streaming sessions. The apparatus includes an encoder to generate an identifier corresponding to a media file of an advertisement, a detector to determine a presence of the identifier in the advertisement presented at a media presentation device, a timing analyzer to determine a time at which the advertisement was presented, and an associator. The associator is to compare the identifier and the time to a streaming session log from a streaming service provider, identify a streaming session in which the advertisement associated with the identifier was presented at the time based on the comparison, and associate a panelist identifier corresponding to the media presentation device with a streaming session identifier corresponding to the streaming session.

Example 2 includes the apparatus as defined in example 1, wherein the encoder is to generate the identifier by placing a watermark onto the media file.

Example 3 includes the apparatus as defined in example 2, wherein the watermark is placed onto the media file as the media file is being streamed on the media presentation device.

Example 4 includes the apparatus as defined in example 2, wherein the watermark includes a randomly selected watermark from a plurality of watermarks, wherein the associating of the panelist identifier is based on the determined time and the randomly selected watermark.

Example 5 includes the apparatus as defined in example 2, wherein the watermark includes at least one dedicated seed (SID).

Example 6 includes the apparatus as defined in example 5, wherein an audience measurement entity is to issue different SIDs of the at least one SID to a streaming service provider, the streaming service provider to randomly stream the different SIDs to the media presentation device.

Example 7 includes the apparatus as defined in example 1, wherein the encoder is to generate the identifier by fingerprinting the media file, and wherein the media file is received from a streaming service provider.

Example 8 includes the apparatus as defined in example 7, wherein the encoder is to generate an audio fingerprint corresponding to audio snippets.

Example 9 includes the apparatus as defined in example 1, wherein the identifier is a first identifier, the advertisement is a first advertisement and the time is a first time, wherein the identifier is to determine a second identifier for a second advertisement presented at the media presentation device, wherein the timing analyzer is to determine a second time at which the second advertisement was presented, and wherein the associator is to compare a streaming session during which the advertisement was presented at the time and the second advertisement was presented at the second time.

Example 10 includes the apparatus as defined in example 1, wherein the identifier includes at least one of a player identification, Internet Protocol address, operating system device type, operating system device characteristics, Internet Service Provider, instances of including ads, and audio elements.

Example 11 includes a method for identifying streaming sessions including generating an identifier corresponding to a media file of an advertisement, determining a presence of the identifier in the advertisement presented at a media presentation device, determining a time at which the advertisement was presented, comparing the identifier and the time to a streaming session log from a streaming service provider, identifying a streaming session in which the advertisement associated with the identifier was presented at the time based on the comparing, and associating a panelist identifier corresponding to the media presentation device with a streaming session identifier corresponding to the streaming session.

Example 12 includes the method as defined in example 11, wherein the generating of the identifier includes placing a watermark onto the media file.

Example 13 includes the method as defined in example 12, wherein the watermark is placed onto the media file as the media file is being streamed on the media presentation device.

Example 14 includes the method as defined in example 12, wherein the watermark includes a randomly selected watermark from a plurality of watermarks, wherein the associating of the panelist identifier is based on the determined time and the randomly selected watermark.

Example 15 includes the method as defined in example 12, wherein the watermark includes at least one dedicated seed (SID).

Example 16 includes the method as defined in example 15, wherein an audience measurement entity to issue different SIDs of the at least one SID to a streaming service provider, the streaming service provider to randomly use the different SIDs.

Example 17 includes the method as defined in example 11, wherein the generating of the identifier includes fingerprinting the media file, and wherein the media file is received from a streaming service provider.

Example 18 includes the method as defined in example 17, wherein the generating of the identifier includes generating an audio fingerprint corresponding to audio snippets.

Example 19 includes the method as defined in example 11, wherein the identifier is a first identifier, the advertisement is a first advertisement and the time is a first time, and further including determining a second identifier for a second advertisement presented at the media presentation device, determining a second time at which the second advertisement was presented, and wherein the comparing includes identifying a streaming session during which the advertisement was presented at the time and the second advertisement was presented at the second time.

Example 20 includes the method as defined in example 11, wherein the identifier includes at least one of a player identification, Internet Protocol address, operating system device type, operating system device characteristics, Internet Service Provider, instances of including ads, and audio elements.

Example 21 includes a non-transitory computer readable medium comprising instructions which, when executed, cause at least one processor to generate an identifier corresponding to a media file of an advertisement, determine a presence of the identifier in the advertisement presented at a media presentation device, determine a time at which the advertisement was presented, compare the identifier and the time to a streaming session log from a streaming service provider, identify a streaming session in which the advertisement associated with the identifier was presented at the time based on the comparison, and associate a panelist identifier corresponding to the media presentation device with a streaming session identifier corresponding to the streaming session.

Example 22 includes the computer readable medium as defined in example 1, wherein the instructions cause the at least one processor to generate the identifier by placing a watermark onto the media file.

Example 23 includes the computer readable medium as defined in example 22, wherein the watermark is placed onto the media file as the media file is being streamed on the media presentation device.

Example 24 includes the computer readable medium as defined in example 22, wherein the watermark includes a randomly selected watermark from a plurality of watermarks, wherein the associating of the panelist identifier is based on the determined time and the randomly selected watermark.

Example 25 includes the computer readable medium as defined in example 22, wherein the watermark includes at least one dedicated seed (SID).

Example 26 includes the computer readable medium as defined in example 25, wherein the instructions cause the at least one processor to issue different SIDs of the at least one SID to a streaming service provider, the streaming service provider to randomly stream the different SIDs to the media presentation device.

Example 27 includes the computer readable medium as defined in example 21, wherein the instructions cause the at least one processor to generate the identifier by fingerprinting the media file, and wherein the media file is received from a streaming service provider.

Example 28 includes the computer readable medium as defined in example 27, wherein the instructions cause the at least one processor to generate an audio fingerprint corresponding to audio snippets.

Example 29 includes the computer readable medium as defined in example 21, wherein the identifier is a first identifier, the advertisement is a first advertisement and the time is a first time, and wherein the instructions cause the at least one processor to determine a second identifier for a second advertisement presented at the media presentation device, determine a second time at which the second advertisement was presented, and identify a streaming session during which the advertisement was presented at the time and the second advertisement was presented at the second time.

Example 30 includes the computer readable medium as defined in example 21, wherein the identifier includes at least one of a player identification, Internet Protocol address, operating system device type, operating system device characteristics, Internet Service Provider, instances of including ads, and audio elements.

Example 31 includes an apparatus for identifying streaming sessions. The apparatus includes at least one memory, instructions, and a processor. The processor is to execute instructions to generate an identifier corresponding to a media file of an advertisement, determine a presence of the identifier in the advertisement presented at a media presentation device, determine a time at which the advertisement was presented, compare the identifier and the time to a streaming session log from a streaming service provider, identify a streaming session in which the advertisement associated with the identifier was presented at the time based on the comparison, and associate a panelist identifier corresponding to the media presentation device with a streaming session identifier corresponding to the streaming session.

From the foregoing, it will be appreciated that example methods, apparatus and articles of manufacture have been disclosed that enable accurate determination and/or characterization of streaming sessions based on identifiers in conjunction with server data. Examples disclosed herein enable data associated with panelists to be effectively controlled (e.g., for privacy or confidentiality concerns, etc.).

It is noted that this patent claims priority to U.S. Patent Application Ser. No. 63/030,888, which was filed on May 27, 2020, and is hereby incorporated by reference in its entirety.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. A method comprising:
receiving, from a metering device and via a network, a presence information characterizing a presence of a person at a media presentation location, wherein the presence information is captured by sensors of the metering device;
receiving, from a Streaming Service Provider (SSP) and via the network, a streaming session log;
comparing an audience measurement information characterizing media presented by a media presentation device to the streaming session log; and
based on a result of the comparison and the presence information captured by the sensors of the metering device, associating a panelist identifier that is specified by the audience measurement information and characterizes the person at the media presentation location with a streaming session identifier included in the streaming session log.

2. The method of claim 1, wherein the metering device is integrated with a media presentation device disposed at the media presentation location.

3. The method of claim 1, wherein the audience measurement information comprises a sequence of media identifiers, and wherein each media identifier is associated with a respective timestamp characterizing a time when the media identifier was detected by the metering device.

4. The method of claim 3, wherein each media identifier is determined by the metering device via audio fingerprinting of the media presented by the media presentation device.

5. The method of claim 3, wherein comparing the audience measurement information characterizing the media presented by the media presentation device to the streaming session log comprises:
comparing the media identifier and the respective timestamp specified by the audience measurement information to a streaming media identifier and a respective streaming timestamp specified by the streaming session log.

6. The method of claim 3, wherein comparing the audience measurement information characterizing the media presented by the media presentation device to the streaming session log comprises:
comparing a sequence of media identifiers specified by the audience measurement information to a sequence of streaming media identifiers specified by the streaming session log.

7. The method of claim 1, further comprising:
assigning demographic information to the streaming session identifier based on the panelist identifier.

8. A computing system comprising:
a processor; and
at least one memory storing instructions that, when executed by the processor, cause the computing system to perform operations comprising:
receiving, from a metering device and via a network, a presence information characterizing a presence of a person at a media presentation location, wherein the presence information is captured by sensors of the metering device;
receiving, from a Streaming Service Provider (SSP) and via the network, a streaming session log;
comparing an audience measurement information characterizing media presented by a media presentation device to the streaming session log; and
based on a result of the comparison and the presence information captured by the sensors of the metering device, associating a panelist identifier that is specified by the audience measurement information and characterizes the person at the media presentation location with a streaming session identifier included in the streaming session log.

9. The system of claim 8, wherein the metering device is integrated with a media presentation device disposed at the media presentation location.

10. The system of claim 8, wherein the audience measurement information comprises a sequence of media identifiers, and wherein each media identifier is associated with a respective timestamp characterizing a time when the media identifier was detected by the metering device.

11. The system of claim 10, wherein each media identifier is determined by the metering device via audio fingerprinting of the media presented by the media presentation device.

12. The system of claim 10, wherein comparing the audience measurement information characterizing the media presented by the media presentation device to the streaming session log comprises:
comparing the media identifier and the respective timestamp specified by the audience measurement information to a streaming media identifier and a respective streaming timestamp specified by the streaming session log.

13. The system of claim 10, wherein comparing the audience measurement information characterizing the media presented by the media presentation device to the streaming session log comprises:
comparing a sequence of media identifiers specified by the audience measurement information to a sequence of streaming media identifiers specified by the streaming session log.

14. The system of claim 8, wherein the operations further comprise:
assigning demographic information to the streaming session identifier based on the panelist identifier.

15. A non-transitory computer readable storage medium having stored thereon program instructions that, upon execution by a processor, cause performance of operations comprising:
receiving, from a metering device and via a network, a presence information characterizing a presence of a person at a media presentation location, wherein the presence information is captured by sensors of the metering device;
receiving, from a Streaming Service Provider (SSP) and via the network, a streaming session log;
comparing an audience measurement information characterizing media presented by a media presentation device to the streaming session log; and
based on a result of the comparison and the presence information captured by the sensors of the metering device, associating a panelist identifier that is specified by the audience measurement information and characterizes the person at the media presentation location with a streaming session identifier included in the streaming session log.

16. The non-transitory computer readable storage medium of claim 15, wherein the metering device is integrated with a media presentation device disposed at the media presentation location.

17. The non-transitory computer readable storage medium of claim 15, wherein the audience measurement information comprises a sequence of media identifiers, and wherein each media identifier is associated with a respective timestamp characterizing a time when the media identifier was detected by the metering device.

18. The non-transitory computer readable storage medium of claim 17, wherein each media identifier is determined by the metering device via audio fingerprinting of the media presented by the media presentation device.

19. The non-transitory computer readable storage medium of claim 17, wherein comparing the audience measurement information characterizing the media presented by the media presentation device to the streaming session log comprises:
comparing the media identifier and the respective timestamp specified by the audience measurement information to a streaming media identifier and a respective streaming timestamp specified by the streaming session log.

20. The non-transitory computer readable storage medium of claim 17, wherein comparing the audience measurement information characterizing the media presented by the media presentation device to the streaming session log comprises:
comparing a sequence of media identifiers specified by the audience measurement information to a sequence of streaming media identifiers specified by the streaming session log.
